(19) United States
(12) Patent Application Publication
(10) Pub. No.: US 2015/0052044 A1
(43) Pub. Date: Feb. 19, 2015

(54) One View/Transaction Monitoring

(71) Applicant: Bank of America Corporation, Charlotte, NC (US)

(72) Inventors: Brandon Castagna, Charlotte, NC (US); Laith Sheet, Phoenix, AZ (US); John Arcidiacono, Jacksonville, FL (US); Brian Kunzie, Charlotte, NC (US); Suresh Jagarlamudi, Charlotte, NC (US); Tim Murphy, Charlotte, NC (US); Michael Galloway, Charlotte, NC (US)

(73) Assignee: Bank of America Corporation, Charlotte, NC (US)

(21) Appl. No.: 13/966,610

(22) Filed: Aug. 14, 2013

(51) Int. Cl. G06Q 40/00

(52) U.S. Cl. CPC G06Q 40/00
USPC 705/39

(57) ABSTRACT

A system for monitoring one or more transactions includes a memory, which stores first metadata, second metadata, and third metadata, communicatively coupled to one or more processors. The one or more processors receive the first metadata from a first transaction processing system, the second metadata from a second transaction processing system, and the third metadata from a third transaction processing system and determine attributes from each of the first, second, and third metadata. Each of the first, second, and third metadata are associated with a task performed by the first, second, and third transaction processing systems, respectively. The one or more processors associate the first metadata with a first transaction. The one or more processors then determine that none of the attributes from the second metadata are the same as any of the attributes from the first metadata and then associate the second metadata with a second transaction. The one or more processors then determine that at least one of the attributes from the third metadata is the same as at least one of more attributes from the first metadata and associate the third metadata with the first transaction.

### TECHNICAL FIELD

This disclosure relates generally to system monitoring, payment processing systems, and, more particularly, to a one view system for transaction monitoring.

### BACKGROUND

An enterprise may offer any number of services to its users. The users, in turn, may take advantage of the offered services and make requests that the enterprise perform certain transactions. In performing these transactions, the enterprise may make use of a collection of various hardware and software systems. Monitoring transactions as they are performed by the various systems may be important to an enterprise for a variety of reasons. For instance, transaction monitoring may allow an enterprise to better understand system errors and provide more responsive customer service to its users. However, because of the heterogeneous nature of the hardware and software systems used to perform these transactions, monitoring the transactions as they are performed by the chain of different systems may be difficult.

### SUMMARY

According to embodiments of the present disclosure, disadvantages and problems associated with previous systems may be reduced or eliminated.

According to one embodiment, a system for monitoring one or more transactions includes a memory, which stores first metadata, second metadata, and third metadata, communicatively coupled to one or more processors. The one or more processors receive the first metadata from a first transaction processing system. The first metadata is associated with a task performed by the first transaction processing system. The one or more processors determine one or more attributes from the first metadata that are associated with the task performed by the first transaction processing system and then associate the first metadata with a first transaction. The one or more processors receive the second metadata from a second transaction processing system that is different from the first transaction processing system. The second metadata is associated with a task performed by the second transaction processing system. The one or more processors determine one or more attributes from the second metadata that are associated with the task performed by the second transaction processing system. The one or more processors then determine that none of the one or more attributes from the second metadata are the same as any of the one or more attributes from the first metadata and then associate the second metadata with a second transaction. The one or more processors receive the third metadata from a third transaction processing system that is different from the first transaction processing system. The third metadata is associated with a task performed by the third transaction processing system. The one or more processors determine one or more attributes from the third metadata that are associated with the task performed by the third transaction processing system. The one or more processors then determine that at least one of the one or more attributes from the third metadata is the same as at least one of the one or more attributes from the first metadata and then associate the third metadata with the first transaction.

According to another embodiment, a method for monitoring one or more transactions includes receiving first metadata from a first transaction processing system. The first metadata is associated with a task performed by the first transaction processing system. The method also includes determining one or more attributes from the first metadata that are associated with the task performed by the first transaction processing system and associating the first metadata with a first transaction. The method also includes receiving second metadata from a second transaction processing system that is different from the first transaction processing system. The second metadata is associated with a task performed by the second transaction processing system. The method includes determining one or more attributes from the second metadata that are associated with the task performed by the second transaction processing system and determining that none of the one or more attributes from the second metadata are the same as any of the one or more attributes from the first metadata. The method includes associating the second metadata with a second transaction. The method also includes receiving third metadata from a third transaction processing system that is different from the first transaction processing system. The third metadata is associated with a task performed by the third transaction processing system. The method includes determining one or more attributes from the third metadata that are associated with the task performed by the third transaction processing system and determining that at least one of the one or more attributes from the third metadata is the same as at least one of the one or more attributes from the first metadata. Finally, the method includes associating the third metadata with the first transaction.

According to another embodiment, a system for monitoring one or more transactions includes a first transaction processing system, a second transaction processing system, and a correlation engine communicatively coupled to the first and second transaction processing systems. The first transaction processing system performs a first task for a transaction and transmits first metadata associated with the performance of the first task to the correlation engine. The second transaction processing system performs a second task for the transaction and transmits second metadata associated with the performance of the second task to the correlation engine. The correlation engine receives the first metadata and the second metadata and then determines one or more attributes from the first metadata that are associated with the first task and determines one or more attributes from the second metadata that are associated with the second task. The correlation engine then determines that at least one attribute associated with the first task is correlated to at least one attribute associated with the second task and associates the first metadata and the second metadata with the transaction.

Certain embodiments of the disclosure may provide one or more technical advantages. For example, monitoring transactions may allow the system to determine whether an error occurred during the processing of a transaction. Additionally, if it is determined that an error occurred, the system may inform other systems that are part of the same transaction to abstain from performing additional tasks, thus conserving power, bandwidth, processing resources, and memory resources over previous systems.

In other embodiments, the transmission of messages containing metadata from different transaction processing systems to the correlation engine at specified intervals may conserve processing power and time over systems where the correlation engine must affirmatively request metadata from the transaction processing systems.

In certain other embodiments, the determination of a correlation among sets of metadata by the correlation engine may allow the system to conserve bandwidth, processing power, and memory storage space over a system in the individual transaction processing systems are used to determine correlations among the sets of metadata.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1a illustrates a block diagram of a system for monitoring a transaction across a plurality of transaction processing systems;

FIG. 1b illustrates another block diagram of a system for monitoring a transaction across a plurality of transaction processing systems;

FIG. 2a illustrates a block diagram of a system for monitoring a payment across a plurality of payment processing systems;

FIG. 2b illustrates another block diagram of a system for monitoring a payment across a plurality of payment processing systems; and

FIG. 3 is a flowchart illustrating a method for monitoring a transaction across a plurality of transaction processing systems.

### DETAILED DESCRIPTION

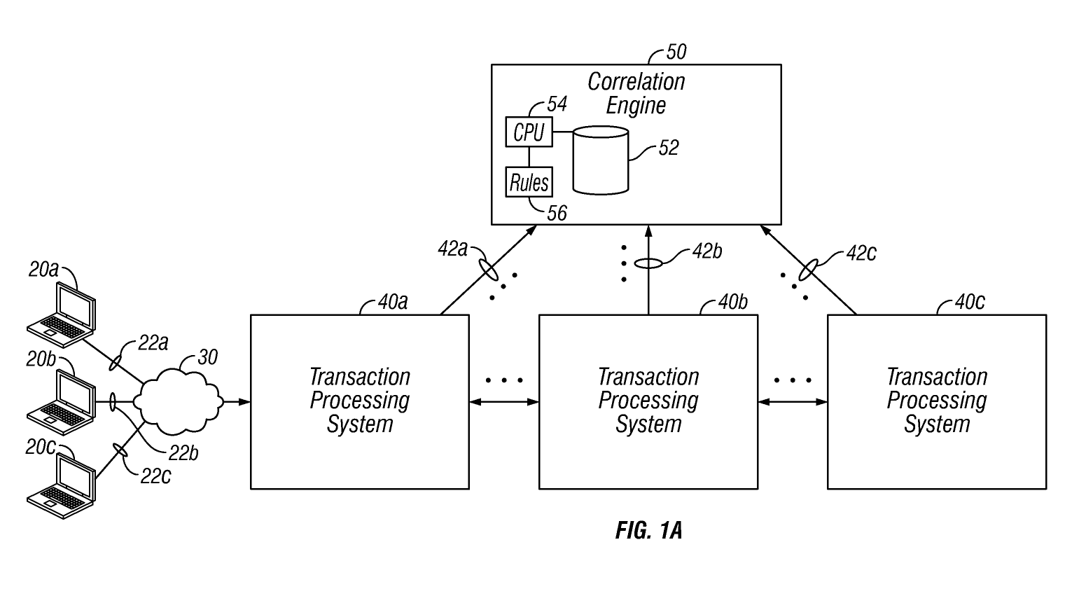

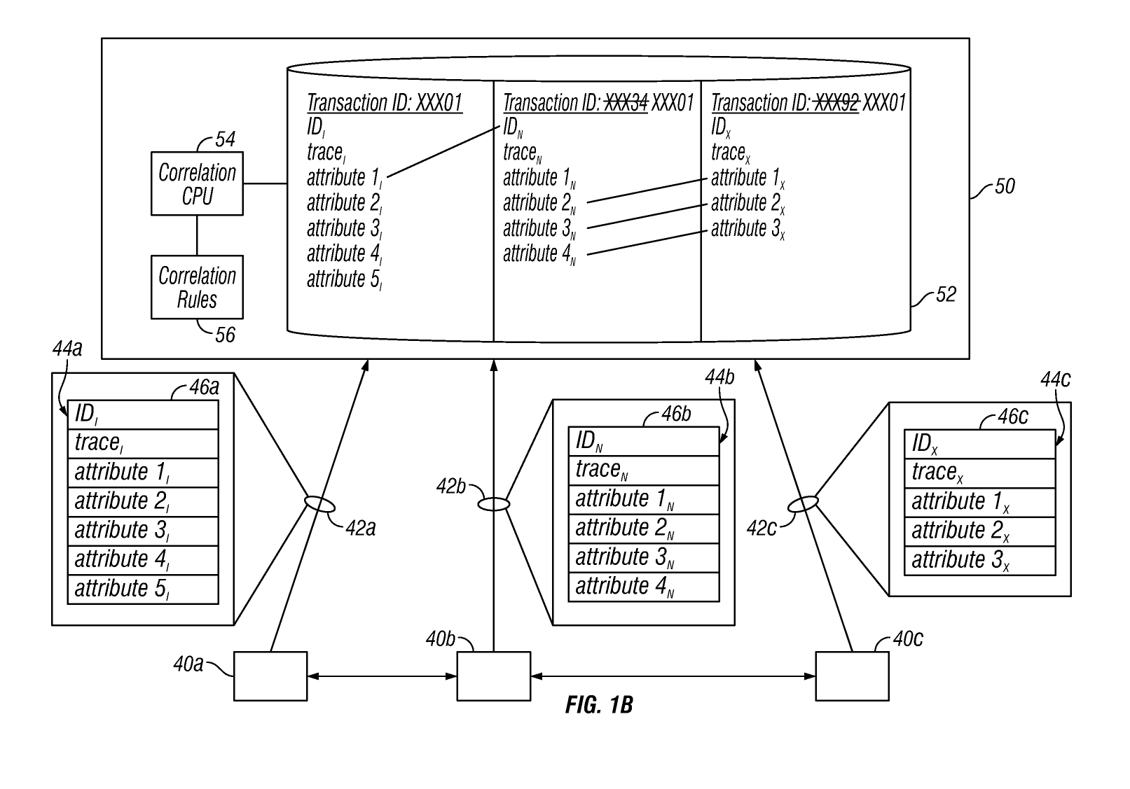

Embodiments of the present disclosure and its advantages are best understood by referring to FIGS. 1 through 3 of the drawings, like numerals being used for like and corresponding parts of the various drawings.

This disclosure describes a system for monitoring a transaction across a plurality of transaction processing systems. Monitoring a transaction while it is being processed may be useful for a variety of reasons. By monitoring which systems have already performed processing on the transaction, an enterprise may be able to calculate an estimated length of time until the overall transaction is completed. As another example, the enterprise may wish to determine whether the transaction will be affected by a failure that is occurring at one of the systems.

A transaction—such as, for example, a payment transaction from one party to another party—may sometimes be completed through the performance of a series of tasks, each completed by one of several different systems. For instance, a first system may receive a user request to make a payment to a third party. The first system may thus perform the task of receiving the user's payment request. After the first system has completed its task, it may then pass the transaction along to a second system to perform another modular task, like payment processing or verification. For some transactions, a large number of systems may be necessary to complete the transactions. The different systems used to complete the overall transaction may sometimes be heterogeneous in nature—for instance, the payment request and the payment processing systems may have been produced by different vendors, may have been produced at different times, or may have been designed to use different software and/or hardware architectures. Thus, the completion of the single transaction may, in some embodiments, comprise a dynamic chain of processing by highly heterogeneous systems. Because of this, it may not be possible to monitor of transaction simply by comparing a particular field or file maintained by one payment processing system with the same field or file maintained by another payment processing system.

Each of the transaction processing systems may, in certain embodiments, be able to track its portion of the transaction (i.e., its own task) within the bounds of its own system. Indeed, as a transaction processing system works to complete its assigned task, it may produce various pieces of metadata. For instance, a transaction processing system may maintain a system specific identifier for each task. Some transaction processing systems, like a payment processing or payment verification system, may store business-related metadata such as the date and time associated with the payment, the amount of the payment, and the account number associated with the payment. When one transaction processing system completes its task and passes the transaction along to the next transaction processing system in the chain, some of this metadata may be passed along to the next transaction processing system as well.

A correlation engine may receive sets of metadata created and stored by the different transaction processing systems and attempt to link the sets of metadata together. For instance, the correlation engine may determine that metadata from one transaction processing system is correlated with metadata from a different transaction processing system. After making this connection, the correlation engine may indicate that the sets of metadata from the two different transaction processing systems are associated with the same overarching transaction. To aid in monitoring the transaction, the correlation engine may assign a unique transaction tracking identifier to the transaction and associate the two (or more) correlated sets of metadata with that transaction tracking identifier. In this way, the correlation engine may track what transaction processing systems have performed tasks related to the transaction—that is, where the transaction has been—and what systems may be next in the chain of processing—that is, where the transaction is going.

As more metadata is received from different systems, the correlation engine may attempt to make more connections. If later received metadata received from another transaction processing system correlates in some way with metadata that has already been associated with a transaction tracking identifier, then that later received metadata may also be associated with the same transaction tracking identifier. By dynamically building this chain of transaction processing systems and related metadata, the correlation engine may enable a user of the system to monitor a transaction as it is performed by the different transaction processing systems.

FIG. 1a illustrates a block diagram of a system 10 for monitoring a transaction across a plurality of transaction processing systems. System 10 includes any suitable number of users 20 who may request that a particular transaction 22 be performed. Transaction 22 may comprise any task that system 10 is capable of performing. While the example transactions 22 discussed in this disclosure are taken from the financial industry, transactions 22 may include any tasks that may be performed by an enterprise during its course of business. For example, a transaction 22 in the logistics and shipping industry could comprise a shipment of goods from one location to another. As another example, a transaction 22 in the pharmaceutical industry could comprise the filling of a prescription. In certain embodiments, the requested transaction 22 might be to transfer funds from user's 20 bank account to a third party account. In certain other embodiments, the requested transaction 22 might be to convert funds in user's 20 account from one type of currency to another type of currency. The requested transaction 22 may require the completion of a plurality of tasks to complete the overall transaction 22. For example, if the requested transaction 22 is to transfer funds from user's 20 bank account to a third party, some tasks that may be used in completing transaction 22 may include receiving the funds transfer request, validating the transfer amount, executing the funds transfer, and performing fraud checks.

Users 20 may utilize any suitable device to request that transaction 22 be performed, including a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 10.

This request that transaction 22 be performed may be routed through network 30 to transaction processing system 40a. This disclosure contemplates any suitable network 30 operable to facilitate communication between the components of system 10. Network 30 may include any interconnecting system capable of transmitting audio, video, signals, data, messages, or any combination of the preceding. Network 30 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. Network 30 may additionally include any combination of gateways, routers, hubs, switches, access points, base stations, wireless telephone systems and any other hardware, software or a combination thereof.

As described above, several tasks may be part of the performance of the overall transaction 22. In certain embodiments, the performance of some of these tasks may be performed by transaction processing system 40a, while other tasks may be performed by transaction processing systems 40b and 40c. Any suitable number and combination of transaction processing systems 40 may be utilized by system 10. In certain embodiments, certain of transaction processing systems 40 may be connectively coupled to other transaction processing systems 40. Using the illustration in FIG. 1a as an example, transaction processing system 40a may be communicatively coupled to transaction processing system 40b; transaction processing system 40b may be communicatively coupled to transaction processing systems 40a and 40c; and transaction processing system 40c may be communicatively coupled to transaction processing system 40b.

In some embodiments, transaction processing systems 40 may comprise systems maintained by different departments of a business or enterprise. For instance, transaction processing system 40a could be a system in the information technology department while transaction processing system 40b could be a system in the accounting department. In certain other embodiments, transaction processing systems 40 may comprise systems maintained among different businesses altogether. For instance, transaction processing system 40a could be owned and operated by a first company while transaction processing system 40b could be owned and operated by a second company. Any combination and arrangement of transaction processing systems 40 that may be used to process transactions 22 is contemplated by this disclosure.

Transaction processing system 40a, upon receiving the request for transaction 22, may be capable of performing a first task with respect to requested transaction 22. In certain embodiments, transaction processing system 40a may simply perform a single task with respect to transaction 22. In certain other embodiments, transaction processing system 40a may perform more than one task with respect to transaction 22.

Transaction processing system 40a may also be operable to create a metadata message 42a. Metadata message 42a may include any electronic transmission that carries data, such as a simple mail transfer protocol (SMTP) message, a short message service (SMS) message, a network packet, a computer file, an email, an HTML request, an XML request, or a combination of these or other suitable transmissions. A metadata message 42 may carry metadata 44 maintained by transaction processing system 40 during the performance of the task as part of transaction 22.

Indeed, while performing their respective tasks, each transaction processing system 40 may maintain various pieces of metadata 44 (as illustrated in FIG. 1b). In certain embodiments, metadata 44 may be received as part of the request from user 20 or from another transaction processing system 40. In certain other embodiments, metadata 44 may be created by transaction processing system 40 during the performance of a task as part of transaction 22. As illustrated in FIG. 1b, each transaction processing system 40 may maintain different metadata 44a, 44b, and 44c.

As will be discussed in detail later, metadata 44a, 44b, and 44c may sometimes store substantially different data. However, in some embodiments, metadata 44 that was produced and/or maintained during the performance of tasks related to the same overall transaction 22 may share the same data, similar data, or otherwise correlated data. Using this correlated data, system 10 may determine how a transaction 22 progresses through system 10—that is, which transaction processing systems 40 have been involved in processing transaction 22, what tasks have been completed with respect to transaction 22, and where transaction 22 may be going next in system 10.

Generally, metadata 44 may comprise any data maintained about a task performed by a transaction processing system 40. Metadata 44 may include, for example, in certain embodiments, technical metadata and/or business metadata. Technical metadata 44 may include a system specific identifier assigned to the task by transaction processing system 40. Each transaction processing system 40 may maintain a different system specific identifier from other transaction processing systems 40 for the same transaction 22. Other technical metadata 44 may include message identifiers, payment identifiers, file names, and/or batch identifiers. Business metadata 44 may include metadata related to the specific transaction 22 requested by user 20. For instance, in some embodiments, business metadata 44 may include a client name, an account number, an amount of funds, a date and/or time, a currency type, and any other suitable information relating to transaction 22.

Metadata 44 may comprise several different attributes 46. For example, each of a message identifier, a payment identifier, an account number, and an amount of funds may, in certain embodiments, comprise an attribute 46. In general, in certain embodiments, each individual piece or portion of metadata 44 may be considered an attribute 46. In some embodiments, an attribute 46 may also identify the particular transaction processing system 40 that maintained metadata 44. An attribute 46 may also indicate a system-specific identifier assigned to a task by the particular transaction processing system 40 that maintained metadata 44. In certain embodiments, attribute 46 may include a trace of the assigned task—that is, it may identify the task that was assigned and/or completed by transaction processing system 40. For instance, an attribute 46 may indicate that a funds transfer request was received or that a fraud check had been completed. Some or all of metadata 44 and attributes 46 may be included in metadata message 42.

Each transaction processing system 40 may be connectively coupled to correlation engine 50. Correlation engine 50 may be capable of receiving metadata messages 42 from transaction processing systems 40. As described above, metadata messages 42 may contain metadata 44 maintained by various transaction processing systems 40. Using metadata 44, correlation engine 50 may be capable of correlating certain metadata 44 received at different times—and sometimes from different transaction processing systems 40—to the same overall transaction 22.

Correlation engine 50 comprises a correlation engine processor 54 communicatively coupled to correlation engine memory 52. Correlation engine processor 54 may include any hardware and/or software that operates to control and process information. Correlation engine processor 54 may be a programmable logic device, a microcontroller, a microprocessor, any suitable processing device, or any suitable combination of the preceding.

The correlation engine memory 52 may store data and information—for instance, metadata 44 contained in metadata messages 42—for use in monitoring transaction 22 across the transaction processing systems 40. Correlation engine memory 52 may store, either permanently or temporarily, data, operational software, or other information for correlation engine processor 54. Correlation engine memory 52 may include any one or a combination of volatile or non-volatile local or remote devices suitable for storing information. For example, correlation engine memory 52 may include random access memory (RAM), read only memory (ROM), magnetic storage devices, optical storage devices, or any other suitable information storage device or a combination of these devices.

In certain embodiments, correlation engine memory 52 may additionally store correlation rules 56. Correlation rules 56 may aid correlation engine processor 54 in monitoring one or more transactions 22 in system 10. Generally, in certain embodiments, correlation rules 56 may allow correlation engine 50 to determine whether different sets of metadata 44 received from transaction processing systems 40 are correlated. In some embodiments, correlation rules may indicate that sets of metadata 44 are correlated if certain attributes 46 from each set of metadata 44 are the same. In certain other embodiments, sets of metadata 44 are related to the same transaction 22 if certain attributes 46 from each set of metadata 44 are related in any other appropriate way as indicated by correlation rules 56. The process of using correlation rules 56 to monitor transactions 22 will be discussed in detail later in this disclosure. Correlation rules may be determined in any appropriate manner, including, but not limited to, analyzing metadata 44 created by different transaction processing systems 40 to find connections among sets of metadata 44 created during a single transaction 22. In other words, in certain embodiments, analysis of metadata 44 maintained by different transaction processing systems 40 for a given transaction 22 may indicate that certain attributes 46 from each metadata 44 may be correlated. These relationships may be maintained by correlation rules 56. Correlation rules 56 may comprise data, an electronic file, software, or any other executable code or module operable to aid correlation engine processor 54 in monitoring one or more transactions 22 in system 10.

If correlation engine 50 determines that metadata 44 from different processing systems 40 is correlated, then the correlation engine 50 may determine that each set of metadata 44 is related to the same transaction 22. Correlation engine 50 may then associate each set of correlated metadata 44 with the same transaction identifier. Associating the transaction tracking identifier with metadata 44 may be performed in any appropriate way, including adding a line to a file that stores metadata 44, adding an additional attribute 46 to metadata 44 that contains the transaction tracking identifier, etc.

Although not illustrated in FIGS. 1a and 1b, the data stored in correlation engine 50 may be accessed by any appropriate party. Viewing such data may enable one to monitor and understand the path of one or more transactions 22 through system 10.

In operation, a business may wish to monitor one or more transactions 22 as they progress through and are completed by a plurality of transaction processing systems 40 in system 10. For the purposes of this example, transaction 22 is completed after transaction processing system 40a completes a first task, transaction processing system 40b completes a second task, and transaction processing system 40c completes a third task. In this example, the request for transaction 22 is received from user 20a by transaction processing system 40a.

Transaction processing system 40a may, in some embodiments, receive certain information regarding transaction 22 in the request from user 20a. Transaction processing system 40a may store some or all of this information in metadata 44a. For example, transaction processing system 40a may store particular business metadata 44a from or relating to the transaction 22. After receiving the request that transaction 22 be performed, transaction processing system 40a may perform the first task for transaction 22.

Referring now to FIG. 1b, before, during, and even after the performance of the first task, transaction processing system 40a may create and maintain metadata 44a. For instance, transaction processing system 40a may assign a system-specific identifier to the first task that is specific to transaction processing system 40a. This is illustrated in FIG. 1b as ID₁. This system-specific identifier may be maintained by transaction processing system 40a in metadata 44a. Transaction processing system 40a may also maintain a description of the first task in metadata 44a, illustrated in FIG. 1b as trace₁. Additionally, transaction processing system 40a may maintain any other appropriate information, identifiers, or other data in metadata 44a. This additional metadata 44a is illustrated in FIG. 1b as attribute1₁, attribute2₁, attribute3₁, attribute4₁, and attribute5₁. As described above, metadata 44a may comprise any appropriate technical and/or business metadata maintained by transaction processing system 40a while performing the first task.

At any appropriate time, transaction processing system 40a may create metadata message 42a that contains metadata 44a and transmit metadata message 42a to correlation engine 50. In certain embodiments, transaction processing system 40a may be automatically configured to transmit metadata message 42a to correlation engine 50 at specified times. In certain other embodiments, correlation engine 50 may be operable to request metadata 44a from transaction processing system 40a or to retrieve metadata 44a directly from transaction processing system 40a without the need for metadata message 42a. Through collecting metadata 44 from different transaction processing systems 40 while they complete tasks for various transactions 22, correlation engine 50 may monitoring transactions 22 in system 10.

As described above, correlation engine 50 may store metadata 44a in correlation engine memory 52. Upon storing metadata 44a, correlation engine 50 may also create a unique transaction tracking identifier and associate metadata 44a with that transaction tracking identifier. As illustrated in FIG. 1b, correlation engine 50 associates a transaction tracking identifier of XXX01 with metadata 44a.

In this example, after transaction processing system 40a has completed the first task for transaction 22, it passes transaction 22 along to transaction processing system 40b to perform the second task. In certain embodiments, the transaction processing system 40a may always pass transaction 22 to transaction processing system 40b. In other embodiments, the decision about to which transaction processing system 40 a transaction 22 should be passed is determined dynamically by transaction processing system 40a. In some embodiments, this determination may be made with reference to the specific transaction 22 at issue. In certain other embodiments, transaction processing system 40a may determine the appropriate transaction processing system 40 based at least in part upon metadata 44a. After making the determination of where the transaction 22 should be passed, transaction processing system 40a may transmit any appropriate data regarding transaction 22 to the appropriate transaction processing system 40—in this example, transaction processing system 40b. Upon receiving transaction 22, transaction processing system 40b may store any appropriate information regarding transaction 22 in metadata 44b. Some of this information may be received from transaction processing system 40a, in certain embodiments. Transaction processing system 40b may then perform the second task for transaction 22. During, before, or even after the performance of the second task, transaction processing system 40b may create and maintain metadata 44b.

For instance, transaction processing system 40b may assign a system-specific identifier to the second task. This is illustrated in FIG. 1b as ID_{N}. This identifier may be maintained by transaction processing system 40b in metadata 44b. In some embodiments, the system-specific identifier assigned to the second task by transaction processing system 40b may be different from the system-specific identifier assigned to the first task by transaction processing system 40a. Transaction processing system 40b may also maintain a description and/or indication of the second task, illustrated in FIG. 1b as trace_{N}. Additionally, transaction processing system 40b may maintain any other appropriate information, identifiers, or other data in metadata 44b, illustrated in FIG. 1b as attribute1_{N}, attribute2_{N}, attribute3_{N}, and attribute4_{N}. Similarly to metadata 44a, metadata 44b may comprise any appropriate technical and/or business metadata maintained by transaction processing system 40b while performing the second task.

As described above with respect to metadata 44a, correlation engine 50 may also receive metadata 44b from transaction processing system 40b. Correlation engine 50 may store the received metadata 44b in correlation engine memory 52. Upon storing metadata 44b, correlation engine 50 may initially create a new, unique transaction tracking identifier and associate metadata 44b with that new transaction tracking identifier. As illustrated in FIG. 1b, correlation engine 50 assigns transaction tracking identifier XXX34 to metadata 44b. It should be noted that this transaction tracking identifier is a different identifier than the one associated with metadata 44a.

Correlation engine 50 may then determine whether metadata 44a and metadata 44b are correlated. Practically, correlation engine 50 may determine, in some embodiments, that metadata 44a and 44b are correlated if certain information from metadata 44a and metadata 44b indicates that metadata 44a and 44b were maintained by transaction processing systems 40 that were processing the same transaction 22. In certain embodiments, if metadata 44a and 44b are correlated, then correlation engine 50 may determine that metadata 44a and 44b are associated with the same transaction 22.

To perform the correlation, in some embodiments, correlation engine 50 may determine one or more attributes 46a from metadata 44a and one or more attributes 46b from metadata 44b. Correlation engine 50 may then determine whether attributes 46a and 46b correlate. If a correlation is determined, correlation engine 50 may associate metadata 44b with the same transaction tracking identifier that was previously associated with metadata 44a, which, in some embodiments, indicates that metadata 44a and 44b are associated with the same transaction 22. If a correlation is not determined, then correlation engine 50 may not associate metadata 44a and metadata 44b with the same transaction 22. In such a case, metadata 44b may retain its originally assigned transaction tracking identifier.

In certain embodiments, the determination of whether metadata 44a and metadata 44b are correlated and should be associated with the same transaction 22 may be made with reference to correlation rules 56. System 10 may use any appropriate correlation rules 56 to determine whether metadata 44a and metadata 44b should be associated with the same transaction 22.

In general, correlation rules 56 may indicate that metadata 44a and 44b should be correlated if the information from metadata 44a and 44b indicate that metadata 44a and 44b relate to the same transaction 22. For example, correlation rules 56 may provide that metadata 44a and 44b should be correlated and associated with the same transaction tracking identifier (and, thus, the same transaction 22) if at least one attribute 46a and at least one attribute 46b have the same or a similar value—e.g., a message identifier from metadata 44a is <message string 1> and a system-specific identifier from metadata 44b is the same or similar to <message string 1>. As another example, correlation rules 56 may provide that metadata 44a and 44b should be correlated if two or more of attributes 46a have the same or similar values as two or more of attributes 46b—e.g., metadata 44a stores an account number of <account string 1> and a transaction value of $100.00 and metadata 44b stores information that is the same or similar to <account string 1> and the $100.00 value. As yet another example, correlation rules 56 may provide that metadata 44a and metadata 44b should be correlated if at least one of attributes 46a and at least one particular attribute 46b share the same or a similar value. Building on this example, correlation rules 56 may indicate that metadata 44a and 44b are correlated if any information from metadata 44a is the same or similar to a message identifier stored in metadata 44b. As yet another example, metadata 44a and metadata 44b should be correlated if a certain attribute 46a and a certain attribute 46b have the same or a similar value—for instance, if a attribute4₁ from metadata 44a is the same as or similar to the attribute2_{N} from metadata 44b. Indeed, as another example in this vein, correlation rules 56 may indicate that metadata 44a and 44b are correlated if a message identifier stored in metadata 44a is the same as or similar to a file name stored in metadata 44b. In the particular example illustrated in FIG. 1b, correlation engine 50 determined that attribute1₁ from metadata 44a was correlated with ID_{N} from metadata 44b. Because correlation engine 50 determined that these two attributes 46 were correlated, correlation engine 50 determined that metadata 44a and metadata 44b were both associated with the same transaction 22. As illustrated in FIG. 1b, correlation engine 50 associates metadata 44b with the same XXX01 identifier associated with metadata 44a.

After transaction processing system 40b has completed the second task for transaction 22, it may pass transaction 22 along to transaction processing system 40c to perform the third task. Transaction processing system 40b transmit any appropriate data regarding transaction 22 to transaction processing system 40c. Upon receiving transaction 22, transaction processing system 40c may store any appropriate information regarding transaction 22 in metadata 44c. Transaction processing system 40c may perform the third task for completion of transaction 22. During, before, and even after the performance of the third task, transaction processing system 40c may create and maintain metadata 44c.

For instance, transaction processing system 40c may assign a system-specific identifier to the third task specific to transaction processing system 40c, illustrated in FIG. 1b as ID_{X}. This identifier may be maintained by transaction processing system 40c in metadata 44c. In some embodiments, the identifier assigned to the third task by transaction processing system 40c may be different than the identifiers assigned to the first task and second task by transaction processing systems 40a and 40b, respectively. Indeed, because transaction processing systems 40 may often assign different system-specific identifiers to tasks for the same transaction 22, monitoring transactions 22 using only these identifiers may not be possible, creating the need for analysis of metadata 44.

Transaction processing system 40c may also maintain a description and/or indication of the third task, illustrated in FIG. 1b as trace_{X}. Additionally, transaction processing system 40c may maintain any other appropriate information, identifiers, or other data in metadata 44c, illustrated in FIG. 1b as attribute1_{X}, attribute2_{X}, and attribute3_{X}. Similarly to metadata 44a and 44b, metadata 44c may comprise any appropriate technical and/or business metadata maintained by transaction processing system 40c while performing the third task.

Again, as described above with respect to metadata 44a and 44b, correlation engine 50 may receive metadata 44c from transaction processing system 40c. Correlation engine 50 may store metadata 44c in correlation engine memory 52. Upon storing metadata 44c, correlation engine 50 may initially create another unique transaction tracking identifier and associate metadata 44c with that transaction tracking identifier. As illustrated in FIG. 1b, correlation engine 50 associates a transaction tracking identifier XXX92 with metadata 44c. It should be noted that this transaction tracking identifier is a different identifier than the one currently associated with metadata 44a and 44b.

Correlation engine 50 may then determine whether metadata 44c is correlated to metadata 44a and 44b and thus whether metadata 44a, 44b, and 44c were all maintained by transactions processing systems 40a, 40b, and 40c, respectively, during the processing of transaction 22. To do so, in some embodiments, correlation engine 50 may determine one or more attributes 46c from metadata 44c. Correlation engine 50 may then determine whether or not attributes 46c correlate to attributes 46b. If a correlation is determined, then correlation engine 50 determines that metadata 44c and metadata 44b are associated with the same transaction 22. In this example, correlation engine 50 determined that attribute2_{N}, attribute3_{N}, and attribute4_{N} from metadata 44b was correlated with attribute1_{X}, attribute2_{X}, and attribute3_{X} from metadata 44c. Because correlation engine 50 determined that these attributes 46 were correlated, correlation engine 50 determined that metadata 44b and metadata 44c were both associated with the same transaction 22. As illustrated in FIG. 1b, correlation engine 50 associates metadata 44c with the same XXX01 identifier associated with metadata 44a and 44b.

It should be noted, of course, that while transaction processing systems 40 are performing the tasks for transaction 22, they may also be performing tasks for other transactions 22 and maintaining additional metadata 44 related to those other transactions 22. Thus, correlation engine 50 may receive metadata 44 related to numerous transactions 22. The process of correlating various attributes 46 from metadata 44 may help to organize various sets of metadata 44 according to which transaction 22 lead to their creation.

Additionally, because correlation engine 50 has now determined that metadata 44a and 44c are associated with the same transaction 22, correlation engine 50 may associate transaction processing systems 40a and 40c that produced metadata 44a and 44c, respectively, with the same transaction 22. Such an association may be made even though transaction processing systems 40a and 40c are not directly coupled and may never communicate directly with one another. By associating transaction processing systems 40 that are not directly coupled with the same transaction 22, correlation engine 50 may provide an end-to-end view of transaction 22, including where transaction 22 has been and where transaction 22 may be going. Thus, system 10 may indicate which transaction processing systems 40 are involved in a single chain of processing for transactions 22 even though many of the transaction processing systems 40 in the chain may not are not directly coupled to one another.

In some embodiments, a transaction may return to a transaction processing system 40 that has already completed a task for transaction 22. For example, transaction processing system 40a complete a task and send transaction 22 on to transaction processing system 40b. Transaction processing system 40b may complete its task for transaction 22 and send it back to transaction processing system 40a for additional processing. Because of the way correlation engine 50 dynamically builds the chain of for transaction 22, correlation engine 50 is able to monitor a transaction 22 despite such forward and backward progressions through the various transaction processing systems 40.

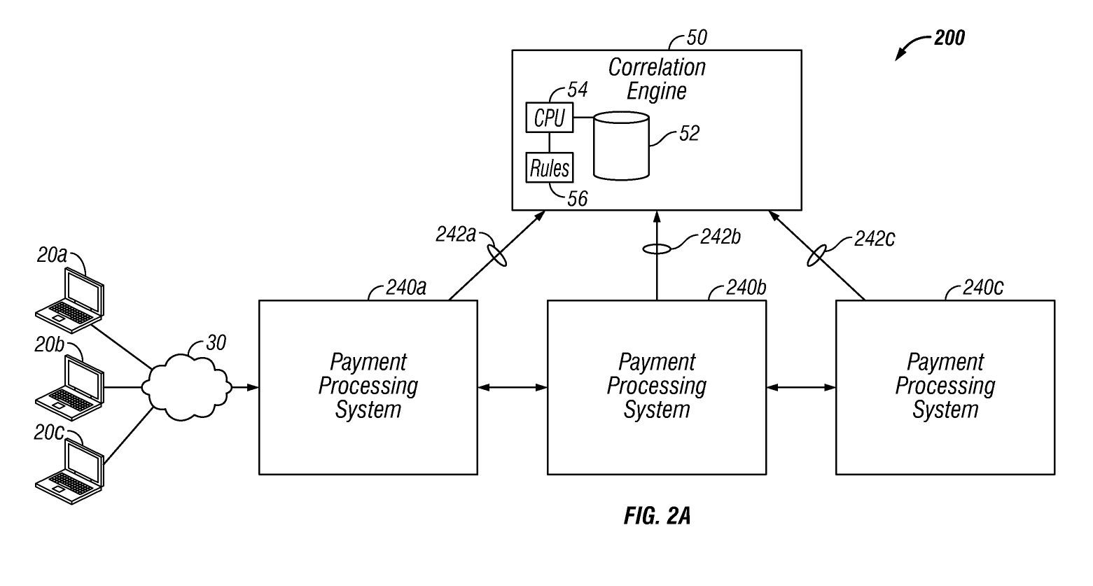

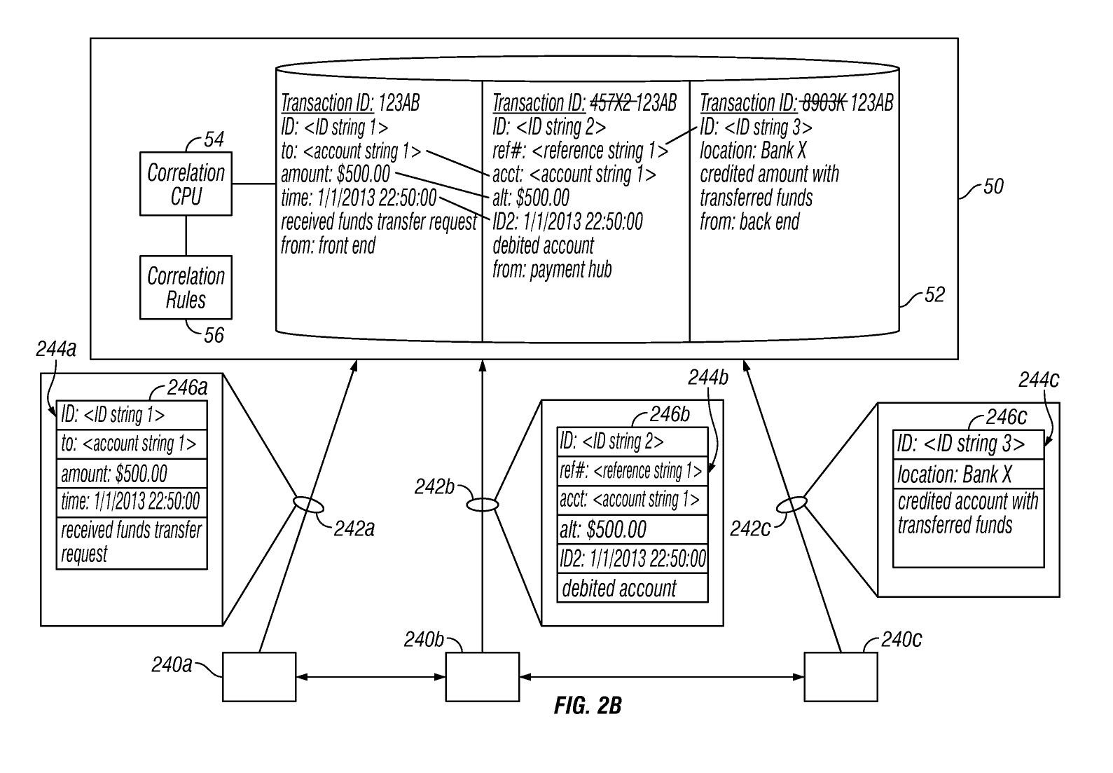

FIGS. 2a and 2b illustrate block diagrams of a particular embodiment of the present disclosure that includes system 200 for monitoring payment 222 across a plurality of payment processing systems 240. In this embodiment, system 200 includes users 20 who may request that a payment 222 be made. System 200 may also include a plurality of payment processing systems 240 that may perform tasks to related to the requested payment 222. In this example embodiment, payment processing system 240a may provide a front-end system for receiving requests for payments 222 from users 20. Payment processing system 240a may comprise a web-based interface or any other appropriate application for receiving such requests. Payment processing system 240b may provide a payment hub or a payment engine to process payments 222. For instance, processing system 240b may debit the account of user 20 with the requested payment amount. Payment processing system 240c may be a back-end system that performs a fraud check on payment 222 and/or executes the actual payment of funds to the receiving account. As discussed above with reference to transaction processing systems 40, each of payment processing systems 240 may be capable of maintaining metadata 242 about the tasks they perform to complete the requested payment 222.

For the purposes of this example, assume that user 20a transmits a request for payment 222. In payment 222, user 20a requests that a payment of $500.00 be made to account number <account string 1>. This request has a date and time of Jan. 1, 2013 at 22:50:00. For purposes of this example, payment 222 is complete after payment processing system 240a receives the request for payment 222 from user 20a, payment processing system 240b debits the account of user 20a for $500.00, and payment processing system 240c executes the transfer of $500.00 to the specified account.

First, in this example embodiment, payment processing system 240a receives the request for payment 222 from user 20a. The request may contain information about payment 222 like the payment amount, the payment account, and the time and date of payment 222. Payment processing system 240a may maintain some, all, or none of this information in metadata 244a. In this example, for instance, payment processing system 240a maintains the payment account number as “to: <account string 1>”, the amount of the transfer as “amount: $500.00”, and the date and time as “time: 1/1/2013 22:50:00” in metadata 244a. In general, payment processing system 240a may maintain metadata 244a in any appropriate format.

Additionally, payment processing system 240a may assign a system-specific identifier to the task it is performing for payment 222. In this example, payment processing system 240a assigns an identifier as “ID: <ID string 1>” to its task for payment 222. Payment processing system 240a may also maintain a trace in metadata 244a, which may, in some embodiments contain a description of the task it is performing for payment 222. Because, in this example, payment processing system 240a performs the task of receiving the request from user 20a, it maintains a trace of “received funds transfer request” in metadata 244a.

Correlation engine 50 may receive metadata 244a from payment processing system 240a. As illustrated in FIG. 2b, metadata 244a is received by correlation engine 50 in metadata message 242a. Correlation engine 50 may then store metadata 244a in correlation engine memory 52. At any appropriate time, correlation engine 50 may determine attributes 246a from metadata 244a. In this example, attributes 246a include “ID: <ID string 1>”, “to: <account string 1>”, “amount: $500.00”, “time: 1/1/2013 22:50:00”, and the trace “received funds transfer request.” Additionally, correlation engine 50 stores an attribute 246 that identifies the source of metadata 244. In this example, correlation engine 50 stores an attribute 246a that identifies that metadata 244a was received “from: front end” payment processing system 240a. Correlation engine 50 additionally associates a payment identifier of 123AB with metadata 244a. This payment identifier indicates that metadata 244a was produced during the performance of a particular payment 222 that is uniquely identified by payment identifier 123AB.

After payment processing system 240a receives the request for payment 222 and performs any other appropriate tasks, payment processing system 240a passes payment 222 to on to the next payment processing system 240. In this example, payment processing system 240a passes payment 222 on to payment processing system 240b to perform the task of debiting the account of user 20a with the payment amount. Payment processing system 240b may receive any appropriate information from payment processing system 240a including, in some embodiments, some or all of metadata 244a. Payment processing system 240b may maintain this information in metadata 244b. As illustrated in FIG. 2b, payment processing system 240b may maintain information in metadata 244b in a different form than it was stored in metadata 244a by payment processing system 240a. For example, payment processing system 240a maintained “to: <account string 1>”, “amount: $500.00”, and “time: 1/1/2013 22:50:00” in metadata 244a. Payment processing system 240b, however, maintains this information differently or in different fields in metadata 244b. For instance, it maintains “acct: <account string 1>”, “alt: $500.00”, and “ID2: 1/1/2013 22:50:00.”

Different payment processing systems 240 may maintain similar or the same information in different formats and fields because of the heterogeneous nature of payment processing systems 240 utilized to complete payments 222. As described earlier, some payment processing systems 240 may have been produced by different vendors, may have been produced at different times, and/or may have been designed to use different software and/or hardware architectures. Thus, the completion of payment 222 may, in some embodiments, require a dynamic chain of processing by highly heterogeneous payment processing systems 240. Because of this, it may not be possible to monitor of a payment 222 simply by comparing a particular field in metadata 244 maintained by one payment processing system 240 with the same field in metadata 244 maintained by another payment processing system 240.

Returning to the example illustrated in FIGS. 2a and 2b, payment processing system 240b assigns an identifier of <ID string 2> to its task for payment 222. Additionally, payment processing system 240b maintains a trace of “debited account” in metadata 244a because it performs the task of debiting user's 20a account with the payment amount. Finally, payment processing system 240b maintains “ref#: <ID string 3>” in metadata 244b, which, in this example, is additional technical metadata.

Correlation engine 50 may receive metadata 244b from payment processing system 240b. As illustrated in FIG. 2b, metadata 244b is received by correlation engine 50 in metadata message 242b. Correlation engine 50 may then store metadata 244b in correlation engine memory 52. At any appropriate time, correlation engine 50 may determine attributes 246b from metadata 244b. In this example, attributes 246b include “ID: <ID string 2>”, “ref#: <ID string 3>”, “acct: <account string 1>”, “alt: $500.00”, “ID2: 1/1/2013 22:50:00”, and the trace “debited account.” Additionally, correlation engine 50 stores data that identifies that metadata 244b was received “from: payment hub” payment processing system 240b. Correlation engine 50 additionally associates a payment identifier of 457XZ with metadata 244b. Because this payment identifier is different from the payment identifier associated with metadata 244a, correlation engine 50, at this point in time, indicates that metadata 244a and 244b are associated with different payments 222.

However, as illustrated in FIG. 2b, after correlation engine 50 makes a correlation between attributes 246a and 246b, it associates metadata 244b with the same payment identifier associated with metadata 244a thus indicating that metadata 244a and 244b are associated with the same payment 222.

As discussed above with reference to FIG. 1b, correlation engine 50 may utilize correlation rules 56 to determine whether a correlation exists between metadata 244 received from different payment processing systems 240. Here, correlation engine 50 determined that three attributes 246a had the same value as three attributes 246b. Specifically, correlation engine 50 determined that metadata 244a and 244b shared a common account number <account string 1>, a common payment amount of $500.00, and a common date and time of 1/1/2013 22:50:00. Correlation rules 56 may indicate that metadata 244 that share these common attributes 246 are part of the same payment 222. Therefore, as a result of the correlation process, correlation engine 50 associates metadata 244b with payment identifier 123AB—the same payment identifier associated with metadata 244a.

At this point, the data stored in correlation engine memory 52 can begin to tell a story of how payment 222 has progressed through system 200. For instance, one could determine from the data that both the “front end” payment processing system 240a and “payment hub” payment processing system 240b have been involved in processing payment 222. Additionally, one could determine from the data that the tasks of “received funds transfer request” and “debited account” have occurred. By dynamically growing this chain of payment processing systems 240 and descriptions of tasks completed, one can gain an end-to-end view of the entire chain of processing for payment 222. Indeed, system 200 of the present disclosure can indicate where payment 222 currently is in the chain of processing, where payment 222 has been, and where payment 222 may be going.

Returning to the example illustrated in FIGS. 2a and 2b, after payment processing system 240b debits the account for payment 222 and performs any other appropriate tasks, payment processing system 240b passes payment 222 on to the next payment processing system 240. In this example, payment processing system 240b passes payment 222 on to payment processing system 240c to perform the task of crediting the appropriate account with the payment amount. Payment processing system 240c may receive any appropriate information from payment processing system 240b including, in some embodiments, some or all of metadata 244b. Payment processing system 240c may maintain this information in metadata 244c. As described above, payment processing system 240c may maintain information in metadata 244c in a different form than it was stored in metadata 244b by payment processing system 240b. Additionally, payment processing system 240c may create additional information and maintain that information in metadata 244c. In this example, payment processing system 240c maintains “ID: <ID string 3>” and “location: Bank X” in metadata 244c. Additionally, payment processing system 240c maintains a trace of “credited account with transferred funds” in metadata 244c because it performs the task of crediting the appropriate account with the payment amount.

Correlation engine 50 may receive metadata 244c from payment processing system 240c. As illustrated in FIG. 2b, metadata 244c is received by correlation engine 50 in metadata message 242c. Correlation engine 50 then stores metadata 244c in correlation engine memory 52. At any appropriate time, correlation engine 50 may determine attributes 246c from metadata 244c. In this example, attributes 246c include “ID: <ID string 3>”, “location: Bank X”, and the trace “credited account with transferred funds.” Additionally, correlation engine 50 stores data that identifies that metadata 244c was received “from: back end” payment processing system 240c. Correlation engine 50 additionally associates a payment identifier of 8903K with metadata 244c. Because this payment identifier is different from the payment identifier associated with metadata 244a and 244b, correlation engine 50, at this point in time, indicates that metadata 244c is associated with a different payment 222 than the payment 222 associated with metadata 244a and 244b.

However, as illustrated in FIG. 2b, after correlation engine 50 makes a correlation between attributes 246b and 246c, it associates metadata 244c with the same payment identifier associated with metadata 244a and 244b thus indicating that metadata 244a, 244b, and 244c are all associated with the same payment 222. Correlation engine 50 determined that an attribute 246b had the same value as an attribute 246c. Specifically, correlation engine 50 determined that metadata 244b and 244c shared a common identifier—stored as “ref#: <ID string 3>” in metadata 244b and as “ID: <ID string 3>” in metadata 244c. Correlation rules 56 may indicate that metadata 244 that share these common attributes 246 are part of the same payment 222. Therefore, as a result of the correlation process, correlation engine 50 associates metadata 244c with payment identifier 123AB—the same payment identifier associated with metadata 244a and 244b.

At this point, processing of payment 222 is complete, and the data stored in correlation engine memory 52 can tell a full story of how payment 222 progressed through system 200. For instance, one could determine from the data that the “front end” payment processing system 240a, the “payment hub” payment processing system 240b, and the “back end” payment processing system 240c were each involved in processing payment 222. Additionally, one could determine from the data that the tasks of “received funds transfer request,” “debited account,” and “credited account with transferred funds” occurred. By dynamically growing this chain of payment processing systems 240 and descriptions of tasks completed, one can gain an end-to-end view of the entire chain of processing for payment 222.

The end-to-end view provided by system 200 described above may confer one or more benefits on an enterprise utilizing system 200. As described above, system 200 monitor certain payments 222 as they progress through system 200. As a result, in certain embodiments, system 200 may be able to estimate how much time remains before the processing of a payment 222 is completed. For example, system 200 may determine that a first task, a second task, and a third task will be performed to complete a payment 222. System 200 may also determine that, on average, the time to complete the first task is thirty seconds, the time to complete the second task is two minutes, and the time to complete the third task is four minutes. Thus, using the results from correlation engine 50, the system 200 may determine that both the first task and the second task have been completed for a particular payment 222. That is, if a particular payment identifier associated with a particular payment 222 indicates that a first payment processing system 240 has completed the first task and that a second payment processing system 240 has completed the second task, then system 200 may determine that only the third task remains. Thus, the estimated time remaining for payment 222 would be four minutes in this example.

In certain embodiments, system 200 may be able to determine which of numerous payment processing systems 240 are involved in handling particular payments 222. Indeed, system 200 may utilize hundreds of different payment processing systems 240 to handle payment processing and may not know which of these systems are utilized to perform certain kinds of payments 222, such as international payments or wire transfers. Because correlation engine 50 dynamically builds a chain of metadata 244 from payment processing systems 240, system 200 may determine which payment processing systems 240 are involved in handling any particular payment 222. Such information may indicate that two payment processing systems 240 that are not directly coupled to one another are nonetheless both involved in processing a particular payment 222. For example, as illustrated in FIGS. 2a and 2b, system 200 could determine that payment processing systems 240a and 240c are both involved in processing payment 222 even though those systems were not directly coupled and did not communicate directly with one another regarding payment 222.

In certain other embodiments, system 200 may enable error checking and correction. For instance, system 200 may determine that an error occurred for a particular payment 222 at a particular payment processing system 240. Because system 200 provides an end-to-end view of where payment 222 is, where it has already been, and where it may be going, system 200 may determine additional payment processing systems 240 that may be affected by the error. For instance, using the example from FIGS. 2a and 2b, if an error occurred at payment processing system 240b, then system 200 could determine that the error could affect payment processing systems 240a and 240c because they are in the same chain of processing for payment 222.

Additionally, system 200 may enable the utilization of certain service level agreements (SLAs). For instance, system 200 may determine that a second task follows the completion of the first task for a particular type of payment 222. System 200 may additionally determine an SLA for the second task that indicates that the second task be completed within thirty seconds. System 200 monitor metadata 244 to determine whether the second task has been performed within the SLA. If it is not completed within the SLA, system 200 may determine that an error has occurred with respect to the second task for payment 222. In certain embodiments, system 200 may generate an alert to indicate that the task has not been performed within the time specified by the SLA.

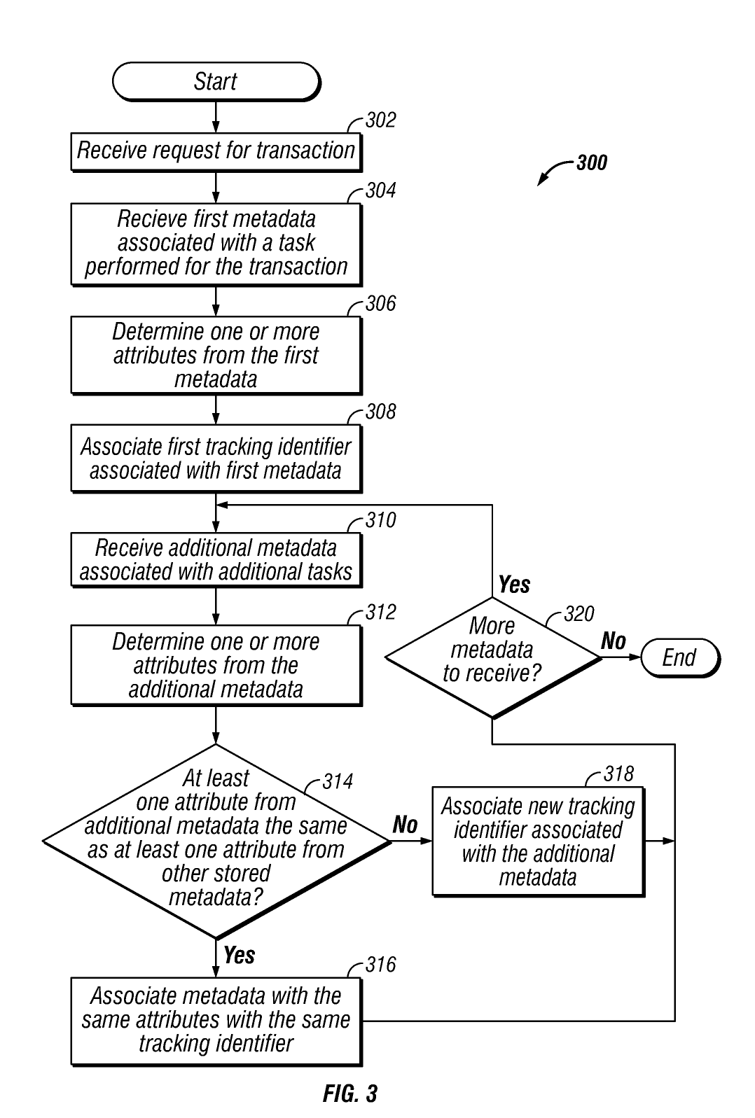

FIG. 3 illustrates an example method for monitoring a transaction 22 across a plurality of transaction processing systems 40. At step 302, system 10 may receive a request for transaction 22 from user 20. This request may be received by any appropriate transaction processing system 40 or by any other appropriate component of system 10. Transaction 22 may be completed after a number of tasks are performed by different transaction processing systems 40 of system 10. As transaction processing systems 40 perform tasks for the completion of transaction 22, transaction processing systems 40 may each maintain metadata 44. This metadata 44 may be transmitted to or retrieved by correlation engine 50 at any appropriate time.

At step 304, correlation engine 50 receives first metadata 44 and stores first metadata 44 in correlation engine memory 52. The first metadata 44 may have been maintained by transaction processing system 40 while transaction processing system 40 performed a task for transaction 22.

At step 306, correlation engine 50 determines one or more attributes 46 from the first metadata 44 and associated with the first task performed by transaction processing system 40. As described above, the one or more attributes 46 may identify the particular transaction processing system 40 that maintained metadata 44. An attribute 46 may also indicate an identifier assigned to a task that is specific to the particular transaction processing system 40 that maintained metadata 44. In certain embodiments, an attribute 46 may include a trace—that is, it may identify the task that was assigned and/or completed by transaction processing system 40. For instance, an attribute 46 may indicate that a funds transfer request was received or that a fraud check had been completed.

At step 308, correlation engine 50 associates metadata 44 with a first transaction identifier. This transaction identifier may be stored in the same file or database structure as metadata 44 or in any other appropriate manner. The transaction identifier indicates that metadata 44 was maintained by transaction processing system 40 while performing a task for a particular transaction 22.

At step 310, correlation engine 52 receives additional metadata 44 and stores additional metadata 44 in correlation engine memory 52. Additional metadata 44 may have been maintained by the same transaction processing system 40 that maintained the first metadata 44 or by a different transaction processing system 40. Further, additional metadata 44 may have been maintained by transaction processing system 40 while transaction processing system 40 was performing a task for the same transaction 22 or a different transaction 22.

At step 312, correlation engine 50 determines one or more attributes 46 from the additional metadata 44 and associated with the a task performed by one of the plurality of transaction processing systems 40 for the same or a different transaction 22.

At step 314, correlation engine 50 determines whether first metadata 44 and additional metadata 44 are correlated. In certain embodiments, if first metadata 44 and additional metadata 44 are correlated, then correlation engine 50 determines that they were maintained by transaction processing systems 40 that were performing tasks as part of the same transaction 22. In certain embodiments, the determination of whether or not first metadata 44 and additional metadata 44 are correlated is aided by correlation rules 56. In some embodiments, correlation rules 56 indicate that first metadata 44 and additional metadata 44 are correlated if at least one attribute 46 from first metadata 44 is the same as at least one attribute 46 from additional metadata 44. In certain other embodiments, correlation rules 56 indicate that first metadata 44 and additional metadata 44 are correlated only if at least three attributes 46 from first metadata 44 are the same as at least three attributes 46 from additional metadata 44.

In general, correlation rules 56 may indicate that sets of metadata 44 should be correlated if the information from the different sets of metadata 44 indicate that they relate to the same transaction 22.

If correlation engine 50 determines that first metadata 44 and additional metadata 44 correlated, then the method continues to step 316. There, correlation engine 50 associates additional metadata 44 with the same transaction identifier as is associated with first metadata 44. By doing so, correlation engine 50 may indicate that first metadata 44 and additional metadata 44 were both maintained during the performance of tasks for the same transaction 22. If additional metadata 44 has already been associated with a different transaction identifier, correlation engine 50 may cause that different transaction identifier to be discarded and may cause the transaction identifier associated with first metadata 44 to be associated with additional metadata 44. Operation continues to step 320 to determine whether there is more metadata 44 to be received by correlation engine 50. If so, operation returns to step 310 to receive additional metadata 44 to correlate to metadata 44 already stored in correlation engine memory 52. If there is no additional metadata to be received, then the method ends.

If correlation engine 50 determines that first metadata and additional metadata are not correlated, then the method proceeds to step 318. There, correlation engine 50 associates a different transaction identifier with additional metadata 44. This may indicate, in some embodiments, that first metadata 44 and additional metadata 44 were maintained during the performance of tasks for the different transactions 22. Operation continues to step 320 to determine whether there is more metadata 44 to be received by correlation engine 50. If so, operation returns to step 310 to receive additional metadata 44 to correlate to metadata 44 already stored in correlation engine memory 52. If there is no additional metadata to be received, then the method ends.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for monitoring one or more transactions, comprising:
a memory operable to store first metadata, second metadata, and third metadata; and
one or more processors communicatively coupled to the memory and operable to:
receive the first metadata from a first transaction processing system, wherein the first metadata is associated with a task performed by the first transaction processing system;
determine one or more attributes from the first metadata and associated with the task performed by the first transaction processing system;
associate the first metadata with a first transaction;
receive the second metadata from a second transaction processing system, wherein the second transaction processing system is different from the first transaction processing system and wherein the second metadata is associated with a task performed by the second transaction processing system;
determine one or more attributes from the second metadata and associated with the task performed by the second transaction processing system;
determine that none of the one or more attributes from the second metadata are the same as any of the one or more attributes from the first metadata;
associate the second metadata with a second transaction;
receive the third metadata from a third transaction processing system, wherein the third transaction processing system is different from the first transaction processing system and wherein the third metadata is associated with a task performed by the third transaction processing system;
determine one or more attributes from the third metadata and associated with the task performed by the third transaction processing system;
determine that at least one of the one or more attributes from the third metadata is the same as at least one of the one or more attributes from the first metadata; and
associate the third metadata with the first transaction.

2. The system of claim 1, wherein the one or more processors are further operable to:
associate the first metadata and third metadata with a first transaction tracking identifier; and
associate the second metadata with a second transaction tracking identifier.

3. The system of claim 1, wherein the one or more processors are further operable to:
receive fourth metadata from a fourth transaction processing system, wherein the fourth transaction processing system is different from the second transaction processing system and wherein the fourth metadata is associated with a task performed by the fourth transaction processing system;
determine one or more attributes from the fourth metadata and associated with the task performed by the fourth transaction processing system;
determine that at least one of the one or more attributes from the fourth metadata is the same as at least one of the one or more attributes from the second metadata; and
associate the fourth metadata with the second transaction.

4. The system of claim 1, wherein:
the one or more attributes from the first metadata and associated with the task performed by the first transaction processing system comprise at least an identifier specific to the first transaction processing system; and
the one or more attributes from the second metadata and associated with the task performed by the second transaction processing system comprise at least an identifier specific to the second transaction processing system.

5. The system of claim 4, wherein the identifier specific to the first transaction processing system is different from the identifier specific to the second transaction processing system.

6. The system of claim 1, wherein:
the first metadata comprises:
a first account number;
a first payment amount; and
a first payment date;
the third metadata comprises:
a third account number;
a third payment amount; and
a third payment date.

7. The system of claim 6, wherein determining that at least one of the one or more attributes from the third metadata is the same as at least one of the one or more attributes from the first metadata further comprises:
determine that the first account number is the same as the third account number;
determine that the first payment amount is the same as the third payment amount; and
determine that the first payment date is the same as to the third payment date.

8. A method for monitoring one or more transactions, comprising:
receiving first metadata from a first transaction processing system, wherein the first metadata is associated with a task performed by the first transaction processing system;
determining one or more attributes from the first metadata and associated with the task performed by the first transaction processing system;
associating the first metadata with a first transaction;
receiving second metadata from a second transaction processing system, wherein the second transaction processing system is different from the first transaction processing system and wherein the second metadata is associated with a task performed by the second transaction processing system;
determining one or more attributes from the second metadata and associated with the task performed by the second transaction processing system;
determining that none of the one or more attributes from the second metadata are the same as any of the one or more attributes from the first metadata;
associating the second metadata with a second transaction;
receiving third metadata from a third transaction processing system, wherein the third transaction processing system is different from the first transaction processing system and wherein the third metadata is associated with a task performed by the third transaction processing system;
determining one or more attributes from the third metadata and associated with the task performed by the third transaction processing system;
determining that at least one of the one or more attributes from the third metadata is the same as at least one of the one or more attributes from the first metadata; and
associating the third metadata with the first transaction.

9. The method of claim 8, further comprising:
associating the first metadata and third metadata with a first transaction tracking identifier; and
associating the second metadata with a second transaction tracking identifier.

10. The method of claim 8, further comprising:
receiving fourth metadata from a fourth transaction processing system, wherein the fourth transaction processing system is different from the second transaction processing system and wherein the fourth metadata is associated with a task performed by the fourth transaction processing system;
determining one or more attributes from the fourth metadata and associated with the task performed by the fourth transaction processing system;
determining that at least one of the one or more attributes from the fourth metadata is the same as at least one of the one or more attributes from the second metadata; and
associating the fourth metadata with the second transaction.

11. The method of claim 8, wherein:
the one or more attributes from the first metadata and associated with the task performed by the first transaction processing system comprise at least an identifier specific to the first transaction processing system; and
the one or more attributes from the second metadata and associated with the task performed by the second transaction processing system comprise at least an identifier specific to the second transaction processing system.

12. The method of claim 11, wherein the identifier specific to the first transaction processing system is different from the identifier specific to the second transaction processing system.

13. The method of claim 8, wherein:
the first metadata comprises:
a first account number;
a first payment amount; and
a first payment date;
the third metadata comprises:
a third account number;
a third payment amount; and
a third payment date.

14. The method of claim 13, wherein determining that at least one of the one or more attributes from the third metadata is the same as at least one of the one or more attributes from the first metadata further comprises:
determining that the first account number is the same as the third account number;
determining that the first payment amount is the same as the third payment amount; and
determining that the first payment date is the same as to the third payment date.

15. A system for monitoring one or more transactions, comprising:
a first transaction processing system operable to:
perform a first task for a transaction; and
transmit first metadata associated with the performance of the first task to a correlation engine;
a second transaction processing system operable to:
perform a second task for the transaction; and
transmit second metadata associated with the performance of the second task to the correlation engine; and
the correlation engine communicatively coupled to the first and second transaction processing systems and operable to:
receive the first metadata and the second metadata;
determine one or more attributes from the first metadata and associated with the first task;
determine one or more attributes from the second metadata and associated with the second task;
determine that at least one attribute associated with the first task is correlated to at least one attribute associated with the second task; and
associate the first metadata and the second metadata with the transaction.

16. The system of claim 15, further comprising:
a third transaction processing system, wherein the third transaction processing system is operable to:
perform a third task for the transaction; and
transmit third metadata created during the performance of the third task to the correlation engine; and
the correlation engine is further operable to:
receive the third metadata;
determine one or more third task attributes associated with the third metadata;
determine that at least one attribute associated with the first task is correlated to at least one attribute associated with the second task; and
associate the third metadata with the transaction.

17. The system of claim 15, wherein associating the first metadata and the second metadata with the transaction further comprises:
associate a transaction tracking identifier with the first metadata; and
associate the transaction tracking identifier with the second metadata.

18. The system of claim 15, wherein the correlation engine is further operable to:
store a service level agreement associated with the second task, wherein the service level agreement comprises a task duration;
before receiving an indication that the second task has been performed, determine that the task duration has elapsed; and
generate an alert, wherein the alert indicates that the second task has not been performed.

19. The system of claim 15, wherein:
the first task comprises receiving a request to transfer funds from a first account to a second account; and
the second task comprises transferring the funds from the first account to the second account.

20. The system of claim 16, wherein:
the third transaction processing system is not communicatively coupled to the first transaction processing system; and
the correlation engine is further operable to determine that the first transaction processing system and the third transaction processing system are associated with the transaction.
